(19) United States
(12) Patent Application Publication
(10) Pub. No.: US 2015/0119519 A1
(43) Pub. Date: Apr. 30, 2015

(54) VINYL ACETATE COPOLYMERS FOR HYDRAULICALLY SETTING CONSTRUCTION MATERIALS

(71) Applicant: Wacker Chemie AG, Munich (DE)

(72) Inventors: Hans-Peter Weitzel, Reischach (DE); Robert Braunsperger, Emmerting (DE); Jessica Seidel, Zangberg (DE)

(21) Appl. No.: 14/404,671

(22) PCT Filed: May 29, 2013
(86) PCT No.: PCT/EP2013/061137

§ 371 Date: Dec. 1, 2014

(30) Foreign Application Priority Data
May 31, 2012 (DE) 10 2012 209 210.2

(51) Int. Cl. C04B 26/08; C08J 3/00

(52) U.S. Cl. CPC C04B 26/08; C08J 3/00; C04B 2111/1006
USPC 524/503

(57) ABSTRACT

Polyvinyl acetate copolymers having specific ranges of vinyl acetate, vinyl chloride, and ethylene show improved adhesion under widely varying conditions when used in hydraulically setting construction materials.

The invention relates to vinyl acetate copolymers, to processes for preparing them, and to building material compositions comprising hydraulically setting binders, fillers, and vinyl acetate copolymers, to their use as bonding mortars, for example, such as tile adhesives for ceramic tiles.

The requirements imposed on hydraulically setting building material compositions, such as tile adhesives, have become ever higher over recent years. It is EN12004 which describes the various performance classifications of cementitious tile adhesives. It gives high-quality adhesives, for example, a designation coding C2. C stands for cementitious adhesives and 2 stands for a tensile adhesive strength of at least 1.0 N/mm² after various forms of storage (determined in accordance with EN1348). The difficulty in practice is to provide hydraulically setting building material compositions which following application to a substrate, exhibit high tensile adhesive strengths both after water storage and after thermal loading. For high tensile adhesive strengths after water storage, hydrophobic copolymers are typically used, such as copolymers of vinyl acetate, Veova10, butyl acrylate or ethylene. Copolymers of these kinds, with a comparatively low glass transition temperature, Tg of <10° C., however, do not exhibit sufficient performance after thermal loading. Conversely, copolymers of, for example, vinyl acetate and Veova10 or copolymers of vinyl acetate and ethylene, with low ethylene content and with a glass transition temperature Tg of >10° C., do exhibit good figures for tensile adhesive strengths after thermal loading, but are highly susceptible after water storage and therefore fail to meet the requisite standard.

As attempted solutions to this problem scenario, mixtures of different polymers have been recommended. For instance, EP2158265 describes polymer mixtures of a vinyl acetate-ethylene copolymer and a copolymer of a vinyl ester of a short-chain carboxylic acid with a vinyl ester of a long-chain carboxylic acid. WO2006/099960 describes polymer mixtures of a polymer having a glass transition temperature of 10 to 80° C. and a polymer having a glass transition temperature of −60 to 20° C., with both polymers containing not more than 70 mol % of vinyl acetate units. In the case of these attempts, therefore, two different polymers are first of all prepared independently of one another and then are mixed, in order to be able to meet the requirements of the standard for the hydraulically setting building material compositions—this, overall, is costly and inconvenient.

EP1262465 describes a copolymer, requiring costly and inconvenient preparation in two stages, from vinyl acetate, ethylene and methyl methacrylate, by polymerization first of vinyl acetate with ethylene and then methyl methacrylate.

Hydraulically setting building material compositions are mass production materials, subject to increasing economic pressure. These economic requirements cannot be met by expensive monomer building blocks, such as methyl methacrylate, butyl acrylate or Veova10, or by costly and inconvenient preparation processes.

Against this background, the object was to provide building material compositions comprising hydraulically setting binders, more particularly mortar compositions, which can be used to meet the C2 standard of EN12004 and which overcome the disadvantages of the prior art.

This object has surprisingly been achieved with building material compositions which comprise vinyl acetate copolymers based on 40 to 80 wt % of vinyl acetate, 15 to 35 wt % of vinyl chloride, 1 to 25 wt % of ethylene and optionally further ethylenically unsaturated comonomers.

In various forms, copolymers of vinyl chloride and ethylene and also vinyl acetate have already been described. For instance, WO05118684 recommends the use of copolymers of vinyl chloride and ethylene in the form of redispersible powders for exterior architectural coatings such as skim coats. Skim coats are thin coatings with film thicknesses of a few millimeters and correspondingly low requirements with regard to the binding force.

EP0149098 describes redispersible dispersion powders based on copolymers of ethylene and further monomers, at least 60% of the further monomers consisting of vinyl chloride. When these dispersion powders are used in tile adhesives, the tensile adhesive strengths of at least 1.0 N/mm2 as required in the C2 standard are not satisfactorily met. With regard to the tensile adhesive strength after thermal storage, no statements at all have been made. The dispersion powder Elotex 10184 comprises a terpolymer based on vinyl acetate, ethylene, and 10 weight percent of vinyl chloride. Even polymers of this kind fail to come up to the requirements of the C2 standard of EN12004.

The invention provides vinyl acetate copolymers obtainable by means of radically initiated polymerization of ethylenically unsaturated monomers in an aqueous medium, characterized in that ethylenically unsaturated monomers used in the polymerization are 40 to 80 wt % of vinyl acetate, 15 to 35 wt % of vinyl chloride, 1 to 25 wt % of ethylene and optionally one or more further ethylenically unsaturated comonomers, the figures in weight percent being based on the total weight of the ethylenically unsaturated monomers employed overall, and adding up to 100 wt %.

The vinyl acetate copolymers are based preferably on 50 to 75 wt % of vinyl acetate, 20 to 30 wt % of vinyl chloride and 5 to 20 wt % of ethylene, the figures in weight percent being based on the total weight of the ethylenically unsaturated monomers employed overall.

Examples of further comonomers are vinyl esters of carboxylic acids having 3 to 15 C atoms, esters of acrylic acid or methacrylic acid, and also olefins other than ethylene, such as propylene.

Preferred vinyl esters of carboxylic acids having 3 to 15 C atoms are vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 C atoms, as for example VeoVa9R or VeoVa10R (tradenames of the company Hexion).

Suitable esters of acrylic acid or methacrylic acid are, for example, esters of unbranched or branched alcohols having 1 to 15 C atoms, such as methyl acrylate, methyl methacrylate, ethyl acrylate, ethyl methacrylate, propyl acrylate, propyl methacrylate, n-butyl acrylate, n-butyl methacrylate, 2-ethylhexyl acrylate, Norbornyl acrylate. Methyl acrylate, methyl methacrylate, n-butyl acrylate and 2-ethylhexyl acrylate are preferred.

Preferred further comonomers are vinyl esters of carboxylic acids having 3 to 15 C atoms.

The further comonomers are used preferably at 0 to 10 wt %, based on the total weight of the ethylenically unsaturated monomers employed overall. The further comonomers comprise preferably less than 5 wt %, more preferably less than 2.5 wt %, and more preferably still less than 1 wt % of esters of acrylic acid or methacrylic acid, each based on the total weight of the ethylenically unsaturated monomers employed overall. Most preferably the vinyl acetate copolymers do not contain any monomer unit of an ester of acrylic acid or methacrylic acid. Most preferably of all, no further comonomers are used.

Optionally it is also possible for auxiliary monomers to be copolymerized at 0.05 to 10 wt %, preferably 0.05 to 5 wt % and more preferably 0.05 to 2.5 wt %, based on the total weight of the ethylenically unsaturated monomers. Examples of auxiliary monomers are ethylenically unsaturated monocarboxylic and dicarboxylic acids, preferably acrylic acid, methacrylic acid, fumaric acid, and maleic acid; ethylenically unsaturated carboximides and carbonitriles, preferably acrylamide and acrylonitrile; monoesters and diesters of fumaric acid and maleic acid such as the diethyl and diisopropyl esters, and also maleic anhydride, ethylenically unsaturated sulfonic acids and their salts, preferably vinyl sulfonic acid, 2-acrylamido-2-methyl-propansulfonic acid. Other examples are precrosslinking comonomers such as polyethylenically unsaturated comonomers, examples being divinyl adipate, diallyl maleate, allyl methacrylate, or triallyl cyanurate, or postcrosslinking comonomers, examples being acrylamidoglycolic acid (AGA), methylacrylamidoglycolic acid methyl ester (MAGME), N-methylolacrylamide (NMA), N-methylolmethacrylamide (NMMA), N-methylolallylcarbamate, alkyl ethers such as the isobutoxy ether or esters of N-methylolacrylamide, of N-methylolmethacrylamide, and of N-methylolallylcarbamate. Also suitable are epoxide-functional comonomers such as glycidyl methacrylate and glycidyl acrylate. Other examples are silicon-functional comonomers, such as acryloyloxypropyltri(alkoxy)- and methacryloyloxypropyltri(alkoxy)-silanes, vinyltrialkoxysilanes, and vinylmethyldialkoxysilanes, in which alkoxy groups present may be methoxy, ethoxy, and ethoxy propylene glycol ether radicals, for example. Mention may also be made of monomers with hydroxyl or CO groups, examples being methacrylic acid and acrylic acid hydroxyalkyl esters such as hydroxyethyl, hydroxypropyl or hydroxybutyl acrylate or methacrylate, and also compounds such as diacetoneacrylamide and acetylacetoxyethyl acrylate or methacrylate.

Preferred vinyl acetate copolymers of the invention, however, contain no (meth)acrylic acid unit and/or no unit of a (meth)acrylic acid derivative, such as the abovementioned silicon-functional comonomers or carbonitriles or more particularly carboxamides, sulfonic acids, epoxyl-functional comonomers, (meth)acrylic acid hydroxyalkyl esters, or acetylacetoxyethyl (meth)acrylate. Preferred vinyl acetate copolymers of the invention also contain no units of precrosslinking comonomers and/or postcrosslinking comonomers. Particularly preferred vinyl acetate copolymers of the invention contain no auxiliary monomer unit.

The monomer selection and the selection of the weight fractions of the monomers are made so as in general to result in a glass transition temperature Tg of −10° C. to +40° C. The glass transition temperature Tg of the polymers can be determined in a known way by means of Differential Scanning calorimetry (DSC). The Tg may also be calculated approximately in advance by means of the Fox equation. According to Fox T. G., Bull. Am. Physics Soc. 1, 3, page 123 (1956), the following is the case: 1/Tg=x₁/Tg₁+x₂/Tg₂+ . . . +xₙ/Tgₙ, where xₙ is the mass fraction (wt %/100) of the monomer n, and Tgₙ is the glass transition temperature, in kelvins, of the homopolymer of the monomer n. Tg values for homopolymers are listed in Polymer Handbook 2nd Edition, J. Wiley & Sons, New York (1975).

Further provided by the invention are processes for preparing the vinyl acetate copolymers by radically initiated polymerization of ethylenically unsaturated monomers in an aqueous medium, characterized in that ethylenically unsaturated monomers polymerized are 40 to 80 wt % of vinyl acetate, 15 to 35 wt % of vinyl chloride, 1 to 25 wt % of ethylene and optionally one or more further ethylenically unsaturated comonomers, the figures in weight percent being based on the total weight of the ethylenically unsaturated monomers employed overall and adding up to 100 wt %.

The vinyl acetate copolymers are prepared generally by the emulsion polymerization process. The polymers in that case are obtained generally in the form of aqueous dispersions. Preference is given to vinyl acetate copolymers in the form of protective colloid-stabilized aqueous dispersions.

The polymerization temperature is generally 40° C. to 150° C., preferably 60° C. to 90° C. The polymerization is initiated using the redox initiator combinations customary for emulsion polymerization. Examples of suitable oxidation initiators are the sodium, potassium and ammonium salts of peroxodisulfuric acid, hydrogen peroxide, tert-butyl peroxide, tert-butyl hydroperoxide, potassium peroxodiphosphate, tert-butyl peroxopivalate, cumene hydroperoxide, isopropylbenzene monohydroperoxide and azobisisobutyronitrile. Preference is given to the sodium, potassium and ammonium salts of peroxodisulfuric acid and hydrogen peroxide. The stated initiators are used generally in an amount of 0.01 to 2.0 wt %, based on the total weight of the ethylenically unsaturated monomers.

Suitable reducing agents are, for example, the sulfites and bisulfites of the alkali metals and of ammonium, such as sodium sulfite, the derivatives of sulfoxylic acid such as zinc or alkali metal formaldehyde-sulfoxylates, as for example sodium hydroxymethanesulfinate (Brüggolit) and (iso-)ascorbic acid. Preference is given to sodium hydroxymethane sulfinate and (iso-)ascorbic acid. The amount of reducing agent is preferably 0.015 to 3 wt %, based on the total weight of the ethylenically unsaturated monomers.

The stated oxidizing agents, more particularly the salts of peroxodisulfuric acid, may also be used on their own as thermal initiators.

To control the molecular weight, it is possible to use substances which have a regulating action during the polymerization. If such substances are used, they are employed customarily in amounts between 0.01 to 5.0 wt %, based on the monomers to be polymerized, and are metered separately or else as a premix with reaction components. Examples of such substances are n-dodecyl mercaptan, tert-dodecyl mercaptan, mercaptopropionic acid, methyl mercaptopropionate, isopropanol and acetaldehyde. With preference no regulating substances are used.

Examples of suitable protective colloids are partially hydrolyzed or fully hydrolyzed polyvinyl alcohols. Preference is given to partially hydrolyzed polyvinyl alcohols having a degree of hydrolysis of 80 to 95 mol % and a Höppler viscosity, in 4% strength aqueous solution, of 1 to 30 mPas (Höppler method at 20° C., DIN 53015). Preference is also given to partially hydrolyzed, hydrophobically modified polyvinyl alcohols having a degree of hydrolysis of 80 to 95 mol % and a Höppler viscosity, in 4% aqueous solution, of 1 to 30 mPas. Examples thereof are partially hydrolyzed copolymers of vinyl acetate with hydrophobic comonomers such as isopropenyl acetate, vinyl pivalate, vinyl ethylhexanoate, vinyl esters of saturated alpha-branched monocarboxylic acids having 5 or 9 to 11 C atoms, dialkyl maleates and dialkyl fumarates such as diisopropyl maleate and diisopropyl fumarate, vinyl chloride, vinyl alkyl ethers such as vinyl butyl ether, and olefins such as ethene and decene. The fraction of the hydrophobic units is preferably 0.1 to 10 wt %, based on the total weight of the partially hydrolyzed polyvinyl alcohols. Mixtures of the stated polyvinyl alcohols may also be used.

Further preferred polyvinyl alcohols are partially hydrolyzed, hydrophobized polyvinyl alcohols, which are obtained by polymer-analogous reaction, as for example acetalization of the vinyl alcohol units with C₁ to C₄ aldehydes such as butylaldehyde. The fraction of the hydrophobic units is preferably 0.1 to 10 wt %, based on the total weight of the partially hydrolyzed polyvinyl acetate. The degree of hydrolysis is for example 80 to 95 mol %, preferably 85 to 94 mol %; the Höppler viscosity (determined in accordance with DIN 53015, Höppler method, in 4% strength aqueous solution at 20° C.) is for example 1 to 30 mPas, preferably 2 to 25 mPas.

The most preferred are polyvinyl alcohols having a degree of hydrolysis of 85 to 94 mol % and a Höppler viscosity in 4% strength aqueous solution of 3 to 15 mPas (Höppler method at 20° C., DIN 53015). The stated protective colloids are accessible by means of methods known to the skilled person.

The polyvinyl alcohols are added during the polymerization generally in an amount of in total 1 to 20 wt %, based on the total weight of the ethylenically unsaturated monomers.

Preferably no cellulose and/or no cellulose derivatives are used as protective colloids. As protective colloids, with particular preference, no further protective colloids besides one or more polyvinyl alcohols are used.

In the process of the invention, polymerization takes place preferably without addition of anionic emulsifiers and more preferably without addition of emulsifiers. If polymerization is carried out with addition of emulsifiers, then preferred amounts of emulsifiers are 0.2 to 5 wt %, based on the monomer amount. Suitable emulsifiers are common anionic, cationic or nonionic emulsifiers, examples being anionic surfactants, such as alkyl sulfates with a chain link of 8 to 18 C atoms, alkyl or alkylaryl ether sulfates with 8 to 18 C atoms in the hydrophobic radical and up to 40 ethylene oxide or propylene oxide units, alkyl- or alkylaryl sulfonates having 8 to 18 C atoms, esters and monoesters of sulfosuccinic acid with monohydric alcohols or alkylphenols, or nonionic surfactants, such as alkyl polyglycol ethers or alkylaryl polyglycol ethers having 8 to 40 ethylene oxide units.

The polymerization may be carried out in pressure reactors and/or unpressurized reactors. As pressure reactors and unpressurized reactors, respectively, it is possible to employ the conventional, appropriately dimensioned steel reactors with stirring facility, heating/cooling systems, and lines for the supply of the reactants and/or removal of the products. The preferred operating pressure in the pressure reactor is 3 to 120 bar, more preferably 10 to 80 bar. The preferred operating pressure in the unpressurized reactor is 100 mbar to 5 bar, more preferably 200 mbar to 1 bar.

The polymerization may take place in a batch or semibatch process or in a continuous process.

In the case of the batch or semibatch processes, the monomers may in their entirety be included in the initial charge or metered in. The procedure adopted is preferably such that 50 to 100 wt %, more particularly more than 70 wt %, of the monomers, based on the total weight of the monomers employed overall, are included in the initial charge, and the remaining monomers are metered in subsequently. Vinyl chloride is preferably included in the initial charge to an extent of at least 50 wt % of the total amount of vinyl chloride, and any remaining residual amount of vinyl chloride is metered in. The metered feeds may be carried out separately (in space and time), or the components to be metered may all, or in part, be metered in in pre-emulsified form.

The protective colloid fraction may be included in its entirety in the initial charge, or else in part metered. Preferably at least 70 wt % of the protective colloids are included in the initial charge, and with particular preference the protective colloid fraction is included in its entirety in the initial charge.

In one preferred embodiment, the polymerization is carried out in a stirred tank cascade comprising one or more, more particularly at least two, pressure reactors and one or more unpressurized reactors, continuously. In a stirred tank cascade, the individual reactors are joined to one another via pipelines. The mass flow runs through the stirred tank cascade, beginning in the first reactor, and then through every further reactor. The individual reactors are preferably arranged in a row, i.e., linearly one after another. All of the substances are preferably supplied continuously, and the end product is taken off continuously preferably from the last reactor, preferably the third reactor, more preferably an unpressurized reactor. Particularly preferred is a combination of two pressure reactors and one unpressurized reactor, more particularly in that order. Preferably at least 75 wt %, more preferably 100 wt %, of the vinyl chloride used overall is metered into the first reactor of the stirred tank cascade.

The first reactor of the stirred tank cascade is preferably a pressure reactor. The last reactor in the stirred tank cascade is preferably an unpressurized reactor.

These specific measures are particularly advantageous for polymerizing with one another the monomer amounts used in accordance of the invention.

The monomer conversion is controlled with the initiator feed. Overall, the initiators are preferably metered in in a manner such that continuous polymerization is ensured.

After the end of the polymerization, more particularly in the pressure reactor, polymerization may be continued in an unpressurized reactor, employing known techniques, for the removal of residual monomer, generally by postpolymerization initiated with redox catalyst. Added to the unpressurized reactors, therefore, are both initiator components, to the extent required for final processing. Volatile residual monomers may also be removed by means of distillation, preferably at a reduced pressure, and optionally with inert entraining gases passed through or over the product, such gases being air, nitrogen, or water vapor, for instance.

The vinyl acetate copolymers obtainable with the process of the invention, in the form of aqueous dispersions, have a solids content of preferably 30 to 75 wt % and more preferably 50 to 65 wt %.

Preference is also given to vinyl acetate copolymers in the form of polymer powders redispersible in water, more particularly in the form of protective colloid-stabilized polymer powders redispersible in water. To prepare the vinyl acetate copolymers in the form of polymer powders redispersible in water, the aqueous dispersions, optionally after addition of protective colloids as a drying aid, are dried, by means of fluidized bed drying, freeze drying or spray drying, for example. The dispersions are preferably spray-dried. The spray drying takes place in customary spray-drying units, in which atomization may take place by means of one-, two- or multi-fluid nozzles or with a rotating disk. The exit temperature is selected generally in the range from 45° C. to 120° C., preferably 60° C. to 90° C., depending on the unit, the Tg of the resin, and a desired degree of drying.

Generally speaking, the drying aid is used in a total amount of 3 to 30 wt %, based on the polymeric constituents of the dispersion. This means that the total amount of protective colloid before the drying operation is to be generally at least 3 to 30 wt %, based on the polymer fraction; used with preference are 5 to 20 wt %, based on the polymer fraction.

Suitable drying aids are, for example, partially hydrolyzed polyvinyl alcohols; polyvinylpyrrolidones; polysaccharides in water-soluble form such as starches (amylose and amylopectin), celluloses and their carboxymethyl, methyl, hydroxyethyl and hydroxypropyl derivatives; proteins such as casein or caseinate, soy protein, gelatin; lignosulfonates; synthetic polymers such as poly(meth)acrylic acid, copolymers of (meth)acrylates with carboxyl-functional comonomer units, poly(meth)acrylamide, polyvinylsulfonic acids, and the water-soluble copolymers thereof; melamine-formaldehyde sulfonates, naphthalene-formaldehyde sulfonates, styrene-maleic acid copolymers, and vinyl ether-maleic acid copolymers. With preference no further protective colloids are employed as polyvinyl alcohol drying aids.

The vinyl acetate copolymers in the form of aqueous dispersions or polymer powders redispersible in water preferably comprise no further protective colloids other than one or more polyvinyl alcohols. Preferred vinyl acetate copolymers in the form of aqueous dispersions or polymer powders redispersible in water contain no anionic emulsifiers, more particularly no emulsifiers.

In the course of nozzle atomization it has proven favorable in many cases to have an antifoam content of up to 1.5 wt %, based on the vinyl acetate copolymers. In order to increase the shelf life by improving the blocking stability, especially in the case of powders with a low glass transition temperature, the powder obtained may be equipped with an anti-blocking agent (anticaking agent), preferably up to 30 wt %, based on the total weight of polymeric constituents. Examples of anti-blocking agents are Ca and Mg carbonate, talc, gypsum, silica, kaolins, silicates having particle sizes preferably in the range from 10 nm to 10 μm.

The viscosity of the feed for atomization is adjusted via the solids content in such a way as to obtain in general a figure of <500 mPas (Brookfield viscosity at 20 revolutions and 23° C.), preferably <250 mPas. The solids content of the dispersion for atomization is generally >35%, preferably >45%.

In order to improve the performance properties it is possible to add further adjuvants in the course of atomization. Further constituents of dispersion powder compositions, present in preferred embodiments, are—for example—pigments, fillers, foam stabilizers, hydrophobizing agents.

Additionally provided by the invention are building material compositions comprising one or more hydraulically setting binders, one or more fillers, and optionally one or more additives, characterized in that the building material compositions further comprise one or more vinyl acetate copolymers of the invention.

Examples of hydraulically setting binders are lime hydrate, fly ash, metakaolin, diatomaceous earth, amorphous silica, gypsum, and preferably cement, such as Portland cements of group CEM I, II and III, trass cement, slag cement, magnesia cement, phosphate cement and/or aluminate cements. White cements may also be used, particularly in order to adjust the color of the building material compositions. Mixtures of hydraulically setting binders may also be employed.

Examples of fillers which can be used include finely ground limestone, or marble, or clay, or talc, or preferably the common silica sands or carbonates, such as calcium carbonates. Typically grain sizes for the fillers are 0.5 to 5.0 mm, preferably 1.0 to 3.0 mm.

Typical formulas of the building material compositions include in general 10 to 50 wt %, more particularly 20 to 45 wt %, of hydraulically setting binders, 0.5 to 15 wt %, more particularly 1 to 10 wt %, of vinyl acetate copolymers, 45 to 80 wt %, preferably 50 to 70 wt %, of fillers, and optionally 0 to 5 wt %, more particularly 0.1 to 3 wt %, of additives, the figures in weight percent being based on the dry weight of the building material compositions and adding up in total to 100 wt %.

The building material compositions are preferably in the form of dry mixtures. The building material compositions are generally converted into aqueous building material compositions by addition of water directly prior to their application.

In order to improve the processing properties, additives may be added to the building material compositions. Customary additives are thickeners, examples being polysaccharides such as cellulose ethers and modified cellulose ethers, starch ethers, guar gum, xanthan gum, polycarboxylic acids such as polyacrylic acid and the partial esters thereof, and also polyvinyl alcohols, which may optionally have been acetalized or hydrophobilically modified, or casein and associative thickeners. Customary additives are also setting accelerators, examples being alkali metal or alkaline earth metal salts of organic or inorganic acids. Mention may further be made of the following: hydrophobizing agents, film-forming assistants, dispersants, foam stabilizers, defoamers, plasticizers, and flow agents.

The building material compositions of the invention may be employed in particular as construction adhesives, renders, filling compounds, flooring compounds, leveling compounds, grouts, jointing mortars, or for concrete modification. Preference is given to their use as thermal insulation composite system adhesives or tile adhesives, especially for ceramic tiles.

Surprisingly it has been found that, in contrast to the common received opinion, the lowering of the vinyl chloride content and raising of the vinyl acetate fraction in the vinyl acetate copolymers in comparison to EP0149098 leads to an improvement in the tensile adhesive strength of the building material products after water storage. Through an increase in the fraction of vinyl acetate, which is less hydrophobic by comparison with vinyl chloride, the skilled person would expect a deterioration in the tensile adhesive strength after water storage. It was also surprising that in spite of the significant vinyl chloride content of the vinyl acetate copolymers of the invention, the building material products exhibited very good tensile adhesive strengths even after thermal storage. For all of these effects, the composition of the vinyl acetate copolymers of the invention proved to be essential. Advantageously, in the context of the inventive procedure, it is also possible to make use exclusively of the monomers that are easy to handle and inexpensively available on the large industrial scale, namely vinyl acetate, ethylene, and vinyl chloride. Vinyl chloride is a traditionally inexpensive monomer by virtue of its production on the basis of rock salt. Another surprise was that vinyl chloride in the quantities according to the invention could be copolymerized with vinyl acetate and ethylene to give polymers with high binding force. In actual fact, as is known, the copolymerization parameters of vinyl chloride with vinyl acetate and ethylene are less favorable than, for example, those of vinyl acetate with ethylene, and so such polymers have hitherto not been considered for the preparation of copolymers having high binding forces.

The examples below serve for further elucidation of the invention:

### Preparation of Vinyl Acetate Copolymers in the Form of Aqueous Dispersions

### EXAMPLE 1 (Ex. 1)

In a stirred tank cascade consisting of two pressure reactors with a volume each of 16 liters and one unpressurized reactor with a volume of 30 liters, a continuous emulsion polymerization is carried out. The three reactors are joined to one another by pipelines. The mass flow traverses the cascade, beginning in the first pressure reactor, then through the second pressure reactor, and lastly through the third reactor. All substances are supplied continuously and the end product is removed continuously from the third reactor. The third reactor is operated under reduced pressure (300 mbar), and excess ethylene and also vinyl chloride are removed from the dispersion under subatmospheric pressure and passed to waste recovery.

Before the beginning of polymerization, the pressure reactors are charged with a dispersion of a copolymer of 92% of vinyl acetate and 8% ethylene, this dispersion is stabilized with 8 wt %, based on total monomer, of a partially hydrolyzed polyvinyl alcohol having a degree of hydrolysis of 88 mol % and a Höppler viscosity of 4 mPas (determined in accordance with DIN 53015 at 20° C. in 4% strength aqueous solution). Preparation takes place in accordance with the prior art familiar to the skilled person, in batch mode, in an emulsion polymerization.

The continuous polymerization takes place at 70° C. and 63 bar; the pressure here is controlled by the ethylene feed and by pressure retention valves between second and third reactors (the latter being the unpressurized reactor).

In the first pressure reactor, the potassium persulfate and Na hydroxymethanesulfinate initiators are added continuously at the rates specified later on below. Moreover, the vinyl acetate, ethylene, and vinyl chloride monomers are added to the first reactor at the rates specified below, along with an aqueous solution of the above-described partially hydrolyzed polyvinyl alcohol.

Metering Rates into Reactor 1:
220 g/h potassium persulfate (3% strength aqueous solution)
220 g/h Na hydroxymethanesulfinate (1.5% strength aqueous solution)
4480 g/h vinyl acetate
1120 g/h vinyl chloride
1175 g/h ethylene
4366 g/h aqueous solution (consisting of 1792 g of a 20% strength aqueous solution of the above-described polyvinyl alcohol, 2573 g of water, 1 g of formic acid, 100 mg of iron ammonium sulfate)

Added continuously to the second pressure reactor are the potassium persulfate and Na hydroxymethanesulfinate initiators, at the rates specified.

Metering Rates into Reactor 2:
500 g/h potassium persulfate (3% strength aqueous solution)
500 g/h Na hydroxymethanesulfinate (1.5% strength aqueous solution)

Added continuously to the unpressurized reactor are the tert-butylhydroperoxide and Na hydroxymethanesulfinate initiators, at the stated rates.

Metering Rates into Reactor 3:
200 g/h tert-butyl hydroperoxide (5% strength aqueous solution)
200 g/h Na hydroxymethanesulfinate (5% strength aqueous solution)

The stirred tank cascade is operated continuously for 24 hours.

The end product is filtered off over 250 μm and dispensed into storage drums.

Of the ethylene used, 85% is recovered, the remainder being discarded on transfer into the third reactor. Accordingly a resulting polymer composition is 68% vinyl acetate, 17% vinyl chloride and 15% ethylene. This assumption is supported by the calculation of Tg by the Fox equation and by comparison with the value measured in practice; in both cases, the figure is 11° C. Further dispersion properties can be found in Table 1.

### EXAMPLE 2 (Ex. 2)

The polymerization takes place in the same way as for example 1, employing the following rates:

Metering Rates into Reactor 1:
250 g/h potassium persulfate (3% strength aqueous solution)
250 g/h Na hydroxymethanesulfinate (1.5% strength aqueous solution)
3916 g/h vinyl acetate
1678 g/h vinyl chloride
1175 g/h ethylene
4366 g/h aqueous solution (consisting of 1792 g of a 20% strength aqueous solution of the polyvinyl alcohol described in Example 1, 2573 g of water, 1 g of formic acid, 100 mg of iron ammonium sulfate)
Metering Rates into Reactor 2:
520 g/h potassium persulfate (3% strength aqueous solution)
520 g/h Na hydroxymethanesulfinate (1.5% strength aqueous solution)
Metering Rates into Reactor 3:
200 g/h tert-butyl hydroperoxide (5% strength aqueous solution)
200 g/h Na hydroxymethanesulfinate (5% strength aqueous solution)

Dispersion properties can be found in Table 1.

### EXAMPLE 3 (Ex. 3)

The polymerization takes place in the same way as for example 1, employing the following rates:

Metering Rates into Reactor 1:
340 g/h potassium persulfate (3% strength aqueous solution)
340 g/h Na hydroxymethanesulfinate (1.5% strength aqueous solution)
3356 g/h vinyl acetate
2237 g/h vinyl chloride
1175 g/h ethylene
3859 g/h aqueous solution (consisting of 1792 g of a 20% strength aqueous solution of the polyvinyl alcohol described in example 1, 2069 g of water, 1 g of formic acid, 100 mg of iron ammonium sulfate)
Metering Rates into Reactor 2:
680 g/h potassium persulfate (3% strength aqueous solution)
680 g/h Na hydroxymethanesulfinate (1.5% strength aqueous solution)
Metering Rates into Reactor 3:
200 g/h tert-butyl hydroperoxide (5% strength aqueous solution)
200 g/h Na hydroxymethanesulfinate (5% strength aqueous solution)

Dispersion properties can be found in Table 1.

### COMPARATIVE EXAMPLE 4 (Cex. 4)

The polymerization takes place in the same way as for example 1, employing the following rates:

Metering Rates into Reactor 1:
120 g/h potassium persulfate (3% strength aqueous solution)
120 g/h Na hydroxymethanesulfinate (1.5% strength aqueous solution)
5037 g/h vinyl acetate
560 g/h vinyl chloride
1175 g/h ethylene
4366 g/h aqueous solution (consisting of 1792 g of a 20% strength aqueous solution of the polyvinyl alcohol described in example 1, 2573 g of water, 1 g of formic acid, 100 mg of iron ammonium sulfate)
Metering Rates into Reactor 2:
280 g/h potassium persulfate (3% strength aqueous solution)
280 g/h Na hydroxymethanesulfinate (1.5% strength aqueous solution)
Metering Rates into Reactor 3:
200 g/h tert-butyl hydroperoxide (5% strength aqueous solution)
200 g/h Na hydroxymethanesulfinate (5% strength aqueous solution)

Dispersion properties can be found in Table 1.

### COMPARATIVE EXAMPLE 5 (Cex. 5)

The polymerization takes place in the same way as for Example 1, employing the following rates:

Metering Rates into Reactor 1:
360 g/h potassium persulfate (3% strength aqueous solution)
360 g/h Na hydroxymethanesulfinate (1.5% strength aqueous solution)
2796 g/h vinyl acetate
2796 g/h vinyl chloride
1287 g/h ethylene
3692 g/h aqueous solution (1791 g of a 20% strength aqueous solution of the polyvinyl alcohol described in example 1, 1900 g of water, 1 g of formic acid, 100 mg of iron ammonium sulfate)
Metering Rates into Reactor 2:
720 g/h potassium persulfate (3% strength aqueous solution)
720 g/h Na hydroxymethanesulfinate (1.5% strength aqueous solution)
Metering Rates into Reactor 3:
200 g/h tert-butyl hydroperoxide (5% strength aqueous solution)
200 g/h Na hydroxymethanesulfinate (5% strength aqueous solution)

Dispersion properties can be found in Table 1.

### COMPARATIVE EXAMPLE 6 (Cex. 6)

A pressure reactor with a volume of 600 liters was charged with the following components:

106 kg of water,
55 kg of a 20% strength aqueous solution of a partially hydrolyzed polyvinyl alcohol having a degree of hydrolysis of 88 mol % and a Höppler viscosity of 4 mPas (determined in accordance with DIN 53015 at 20° C. in 4% strength aqueous solution),
51 g of formic acid (85% strength in water),
552 g of iron ammonium sulfate solution (1% strength in water).

The reactor was evacuated. Subsequently 138 kg of vinyl acetate and 17 kg of vinyl chloride were added to the initial charge. The reactor was then heated to 55° C. and charged with an ethylene pressure of 53 bar (corresponding to an amount of 42 kg of ethylene).

The polymerization was commenced by beginning of the metering of a 3% strength aqueous potassium persulfate solution and of a 1.5% strength aqueous Na hydroxymethanesulfinate solution (Brüggolit) each at a rate of 4.3 kg/h. Thirty minutes after the start of polymerization, a monomer mixture consisting of 69 kg of vinyl acetate and 11 kg of vinyl chloride was metered in over 2.5 hours. An aqueous feed consisting of 33 kg of the aforementioned 20% strength polyvinyl alcohol solution and 17 kg of water was metered in, likewise 30 minutes after the start of reaction, at a rate of 20 kg/h over a period of 2.5 hours. After the end of the monomer feed and of the aqueous feed, the initiator feeds ran for a further 90 minutes, in order to polymerize the batch to exhaustion. The total polymerization time was five hours.

The dispersion was subsequently transferred into the unpressurized reactor, in which a pressure of 0.7 bar was applied, in order to separate off excess ethylene and vinyl chloride, and the dispersion therein was postpolymerized by addition of 1.6 kg of a 10% strength aqueous tert-butyl hydroperoxide solution and 1.6 kg of a 5% strength aqueous Na hydroxymethanesulfinate solution (Brüggolit). The pH was adjusted to 5 by addition of sodium hydroxide (10% strength aqueous solution). Lastly the batch is discharged from the unpressurized reactor via a 250 μm sieve.

Dispersion properties can be found in Table 1.

### EXAMPLE 7 (Ex. 7)

Analogous to comparative example 6, with the following changes to the monomer composition.

### Initial Charge:

111 kg of vinyl acetate and 41 kg of vinyl chloride

### Feed:

55 kg of vinyl acetate and 28 kg of vinyl chloride

All further amounts and parameters were analogous to comparative example 6.

Dispersion properties can be found in Table 1.

### COMPARATIVE EXAMPLE 8 (Cex. 8) Analogous to comparative example 6, with the following changes to the monomer composition.

### Initial Charge:

83 kg of vinyl acetate and 70.5 kg of vinyl chloride

### Feed:

34.5 kg of vinyl acetate and 47 kg of vinyl chloride

All further amounts and parameters were analogous to comparative example 6.

Dispersion properties can be found in Table 1.

### COMPARATIVE EXAMPLE 9 (Cex. 9)

By analogy with Example I of EP0149098, a dispersion was prepared with the composition of 16% vinyl acetate, 64% vinyl chloride and 20% ethylene.

Dispersion properties can be found in Table 1.

### COMPARATIVE EXAMPLE 10 (Cex. 10)

Vinyl acetate-ethylene copolymer dispersion (92 wt % vinyl acetate, 8 wt % ethylene), stabilized with 8 wt % polyvinyl alcohol 04/88.

TABLE 1
Properties of the aqueous dispersions of the vinyl
acetate copolymers:

| | | | | | | | Composition |
|---|---|---|---|---|---|---|---|
| | | | | | | | of the Vac/ |
| | | | | | | | VC/E |
| Exam- | SC^{a)} | | Viscosity^{b)} | Dw^{c)} | Tgₑₓₚ^{d)} | Tg_{calc}^{e)} | copolymers^{f)} |
| ple | [%] | pH | [mPas] | [nm] | [° C.] | [° C.] | [wt %] |
| Ex. 1 | 55.0 | 2.5 | 190 | 1320 | 11.0 | 11.3 | 68/17/15 |
| Ex. 2 | 54.5 | 2.5 | 210 | 1050 | 13.4 | 15.1 | 59/26/15 |
| Ex. 3 | 55.0 | 2.4 | 220 | 1060 | 18.5 | 18.6 | 51/34/15 |
| Cex. 4 | 57.1 | 2.6 | 270 | 1640 | 12.6 | 10.1 | 76/9/15 |
| Cex. 5 | 54.1 | 2.7 | 210 | 920 | 18.7 | 20.3 | 42/42/16 |
| Cex. 6 | 55.3 | 3.1 | 420 | 680 | 11.5 | 9.3 | 75/10/15 |
| Ex. 7 | 54.8 | 3.2 | 350 | 750 | 14.2 | 14.3 | 60/25/15 |
| Cex. 8 | 54.3 | 3.1 | 450 | 790 | 19.6 | 20.3 | 42.5/42.5/ |
| | | | | | | | 15 |
| Cex. 9 | 63.8 | 7.0 | 16800 | 760 | 8.0^{h)} | 22.3 | 16/64/20 |

^{a)}SC: solids content of aqueous dispersion, determined according to EN ISO 3251;
^{b)}determined at 23° C. by means of a Brookfield viscometer with spindle 5 and 20 revolutions per minute;
^{c)}determined with the Beckmann Coulter LS instrument according to ISO 13320;
^{d)}glass transition temperature Tg determined experimentally; determined according to DIN 53765;
^{e)}glass transition temperature Tg calculated using the Fox equation;
^{f)}Vac stands for vinyl acetate, VC stands for vinyl chloride and E for ethylene;
^{h)}Dispersion contains plasticizer.

### Preparation of Vinyl Acetate Copolymers in the Form of Powders Redispersible in Water

The dispersion of the respective (comparative) example 1 to 10 from Table 2 was admixed with 2.0 wt %, based on the polymer content of the dispersion (solid/solid), of a partially hydrolyzed polyvinyl alcohol having a degree of hydrolysis of 88 mol % and a Höppler viscosity of 13 mPas and with 6.5 wt %, based on the polymer content of the dispersion (solid/solid), of a partially hydrolyzed polyvinyl alcohol having a degree of hydrolysis of 88 mol % and a Höppler viscosity of 4 mPas (determined in each case according to DIN 53015 at 20° C. in 4% strength aqueous solution). This was followed by customary spray drying, with an entry temperature of 130° C. and an exit temperature of 80° C., and the respective vinyl acetate copolymer was obtained in the form of a powder redispersible in water. The powders were admixed with 3 wt % of kaolin and 14 wt % of calcium carbonate as anticaking agents.

TABLE 2
vinyl acetate copolymers in the form of powders:

| Powder | Dispersion |
|---|---|
| P1 | Ex. 1 |
| P2 | Ex. 2 |
| P3 | Ex. 3 |
| PC4 | Cex. 4 |
| PC5 | Cex. 5 |
| PC6 | Cex. 6 |
| P7 | Ex. 7 |
| PC8 | Cex. 8 |
| PC9 | Cex. 9 |
| PC10 | Cex. 10 |

### Testing of the Vinyl Acetate Copolymers in Tile Adhesives

The powders were investigated for their suitability for the bonding of ceramic tiles. Dry mortars with the following composition were produced:

420 parts by weight Milke cement 42.5
446 parts by weight silica sand
80 parts by weight calcium carbonate
4 parts by weight Tylose MB60000
10 parts by weight calcium formate
40 parts by weight dispersion powder.

To each 100 g of dry mortar, 25 g of water were used.

Testing in accordance with EN1348 (tensile adhesive strength) and EN1346 (open time) gave the testing outcomes listed in Table 3.

TABLE 3
Results of tensile adhesive testing in the tile adhesive:

| | Tensile adhesive strength [N/mm²] | | | | |
|---|---|---|---|---|---|
| | Standard | | | | Open |
| Powder | conditions^{a)} | Water^{b)} | Thermal^{c)} | FT^{d)} | time 30′ |
| P1 | 1.95 | 1.22 | 1.85 | 1.26 | 0.73 |
| P2 | 1.92 | 1.28 | 2.00 | 1.41 | 0.85 |
| P3 | 1.98 | 1.29 | 1.78 | 1.39 | 0.83 |
| PC4 | 2.05 | 0.74 | 1.94 | 0.82 | 0.74 |
| PC5 | 1.96 | 0.85 | 1.55 | 0.91 | 0.45 |
| PC6 | 1.96 | 0.77 | 1.85 | 0.93 | 0.65 |
| P7 | 1.88 | 1.19 | 1.86 | 1.22 | 0.78 |
| PC8 | 1.68 | 0.77 | 1.57 | 0.85 | 0.37 |
| PC9 | 1.75 | 0.83 | 1.45 | 0.90 | 0.42 |
| PC10 | 2.20 | 0.65 | 2.10 | 0.73 | 0.95 |

^{a)}Testing after the standard conditions storage in line with EN1348;
^{b)}Testing after the water storage in line with EN1348;
^{c)}Testing after the thermal storage in line with EN1348;
^{d)}Testing after the freeze-thaw storage in line with EN1348.

After all forms of storage, the inventive dispersion powders P1, P2, P3 and P7 show values well above 1.0 N/mm². The open time after 30 minutes, as well, corresponds to the EN1346 standard requirement of 0.5 N/mm². The dispersion powders with a lower vinyl chloride fraction, in the PC4 and PC6 polymer, do not achieve the standard requirement of 1.0 N/mm² after water storage. The same is true of the dispersion powders with a higher vinyl chloride fraction in PC5, PC8 and PC9. These powders additionally show a drop in the values after thermal storage and in the open time. Powder PC10, comprising a vinyl acetate ethylene copolymer, likewise fails to achieve the required 1.0 N/mm² after water storage.

1-13. (canceled)

14. A vinyl acetate copolymer in the form of a protective colloid-stabilized aqueous dispersion or protective colloid-stabilized polymer powder redispersible in water, said copolymer obtained by polymerizing ethylenically unsaturated monomers by means of radically initiated polymerization in an aqueous medium and optionally subsequent drying, wherein ethylenically unsaturated monomers used in the polymerization comprise 40 to 80 wt. % of vinyl acetate, 15 to 35 wt. % of vinyl chloride, 1 to 25 wt. % of ethylene and optionally one or more further ethylenically unsaturated comonomers, the figures in weight percent being based on the total weight of the ethylenically usaturated monomers and adding up to 100 wt. %, and wherein no cellulose and no cellulose derivatives are included as protective colloids.

15. The vinyl acetate copolymer of claim 14, wherein the vinyl acetate copolymer comprises 50 to 75 wt. % of vinyl acetate, 20 to 30 wt. % of vinyl chloride, and 5 to 20 wt. % of ethylene, the figures in weight percent being based on the total weight of the ethylenically unsaturated monomers and adding up to 100 wt. %.

16. The vinyl acetate copolymer of claim 14, wherein no further comonomers are used in the polymerization.

17. The vinyl acetate copolymer of claim 15, wherein no further comonomers are used in the polymerization.

18. A process for preparing a vinyl acetate copolymer of claim 14, comprising polymerizing ethylenically unsaturated monomers by means of radically initiated polymerization in an aqueous medium and optionally subsequent drying, wherein ethylenically unsaturated monomers polymerized comprise 40 to 80 wt. % of vinyl acetate, 15 to 35 wt. % of vinyl chloride, 1 to 25 wt. % of ethylene and optionally one or more further ethylenically unsaturated comonomers, the figures in weight percent being based on the total weight of the ethylenically unsaturated monomers and adding up to 100 wt. %, and wherein no cellulose and no cellulose derivatives are used as protective colloids.

19. The process of claim 18, wherein the polymerization takes place by a batch, semibatch, or a continuous process.

20. The process for preparing a vinyl acetate copolymer of claim 19, wherein in the case of batch or semibatch processes, at least 50 wt % of the total amount of vinyl chloride is included in the initial charge and any remaining residual amount of vinyl chloride is metered in.

21. The process for preparing a vinyl acetate copolymer of claim 19, wherein in the case of the continuous process the polymerization is carried out in a stirred tank cascade comprising one or more pressure reactors and one or more unpressurized reactors.

22. The process for preparing a vinyl acetate copolymer of claim 21, wherein at least 75 wt. % of the total amount of vinyl chloride is metered into the first reactor of the stirred tank cascade.

23. A building material composition comprising one or more hydraulically setting binders, one or more fillers, and optionally one or more additives, wherein the building material composition further comprises at least one vinyl acetate copolymer of claim 14.

24. A building material composition comprising one or more hydraulically setting binders, one or more fillers, and optionally one or more additives, wherein the building material composition further comprises at least one vinyl acetate copolymer of claim 15.

25. A building material composition comprising one or more hydraulically setting binders, one or more fillers, and optionally one or more additives, wherein the building material composition further comprises at least one vinyl acetate copolymer of claim 16.

26. The building material composition of claim 23, wherein the building material composition comprises 10 to 40 wt. % of hydraulically setting binders, 0.5 to 15 wt. % of vinyl acetate copolymers, 45 to 80 wt. % of fillers, and optionally 0 to 5 wt. % of additives, the figures in weight percent being based on the dry weight of the building material composition and adding up in total to 100 wt. %.

27. The building material composition of claim 23 which is a construction adhesive, render, filling compound, leveling compound, grout, or jointing mortar or is a modifier for concrete.

28. The building material composition of claim 23 which is a thermal insulation composite system adhesive or tile adhesive.
